(19) United States
(12) Patent Application Publication
(10) Pub. No.: US 2015/0116702 A1
(43) Pub. Date: Apr. 30, 2015

(54) DEFECT INSPECTION METHOD AND DEFECT INSPECTION DEVICE

(71) Applicant: Hitachi High-Technologies Corporation, Tokyo (JP)

(72) Inventors: Shunichi Matsumoto, Tokyo (JP); Toshifumi Honda, Tokyo (JP); Yuta Urano, Tokyo (JP); Takahiro Jingu, Tokyo (JP)

(21) Appl. No.: 14/399,972

(22) PCT Filed: Apr. 23, 2013
(86) PCT No.: PCT/JP2013/061959

§ 371 Date: Nov. 10, 2014

(30) Foreign Application Priority Data
May 11, 2012 (JP) 2012-109021

(51) Int. Cl. G01N 21/95; G01T 1/18; G01T 1/20; G01N 21/47

(52) U.S. Cl. CPC G01N 21/9501; G01N 21/47; G01T 1/18; G01T 1/2018; G01N 2201/06113
USPC 356/237.5

(57) ABSTRACT

To enable the detection of a more minute defect with a defect detection device, the defect inspection device is provided with: an illumination light irradiating section that irradiates illumination light on a linear area of a specimen from an inclined direction; a detection optical system section provided with multiple detection optical systems that comprise objective lenses and two-dimensional detectors, said objective lenses being placed in a direction substantially orthogonal to the length direction of the linear area, being placed in a surface that contains a normal line to the specimen front surface, and condensing scattered light generated from the linear area on the specimen, and said two-dimensional detectors detecting the scattered light condensed by the objective lenses; and a signal processing section that processes a signal detected by the detection optical system section and detects the defect on the specimen.

### BACKGROUND

The present invention relates to a defect inspection method and a defect inspection device for inspecting a minute defect on the specimen surface, and outputting determination results of position, type and dimension of the defect.

On the manufacturing line of the semiconductor substrate, the thin film substrate and the like, the defect inspection on the surface of the semiconductor substrate and thin film substrate has been conducted for the purpose of retaining and improving the product yield. The defect inspection as related art is disclosed by Japanese Patent Application Laid-Open No. 8-304050 (Patent Literature 1), Japanese Patent Application Laid-Open No. 2008-26814 (Patent Literature 2), and Japanese Patent Application Laid-Open No. 2008-261790 (Patent Literature 3).

### CITATION LIST

### Patent Literature

Patent Literature 1: Japanese Patent Application Laid-Open No. 8-304050

Patent Literature 2: Japanese Patent Application Laid-Open No. 2008-26814

Patent Literature 3: Japanese Patent Application Laid-Open No. 2008-261790

Patent Literature 1 discloses the technique for improving detection sensitivities through the illumination optical system for linear illumination, and the detection optical system for detecting the illuminated region divided with the line sensor so that the same defect is illuminated a plurality of times in the single inspection, and the resultant scattered lights are added.

Patent Literature 2 discloses the technique which linearly arrays 2n APDs (Avalanche PhotoDiode) corresponding to the laser light pattern, and combines any appropriate two of those 2n APDs. Each difference between output signals of the respective combined two APDs is calculated so as to cancel noise resulting from reflecting light and output the defect pulse to the scattered light.

Patent Literature 3 discloses the technique which arrays the optical lens shaped by cutting the circular lens along two parallel straight lines, and a plurality of corresponding detectors so as to detect the scattered light.

### SUMMARY

The defect inspection carried out in the manufacturing process of the semiconductor and the like is required to satisfy conditions including detection of the minute defect, high-precision measurement of the dimension of the detected defect, nondestructive inspection of the specimen (without deteriorating the specimen, for example), provision of substantially stabilized inspection result with respect to the number of detected defects, defect position, defect dimension, and defect type derived from the inspection of the same specimen, and capability of inspecting a large number of specimens during a given period of time.

With the technique as disclosed in Patent Literature 1, 2 and 3, for detecting the minute defect especially with the dimension of 20 nm or smaller, the scattered light generated from the defect becomes extremely feeble. This makes it impossible to detect such defect because the defect signal is buried in noise caused by the scattered light generated on the specimen surface, noise of the detector or noise of the detection circuit. Alternatively, if the illumination power is increased for the purpose of avoiding the aforementioned noise, the specimen temperature is increased because of the illumination light to cause the thermal damage to the specimen. If the specimen scanning rate is reduced for the purpose of avoiding the damage, the area of the specimen, which can be inspected in a given time period, or the number of the specimens is decreased. It is therefore difficult to perform the high-speed detection of the minute defect.

The photon count method has been known for detecting the feeble light. Generally, the feeble light is subjected to the photon count process for counting the detected photons so that the SN ratio of the signal is improved, thus providing stabilized high-precision signal with high sensitivity. As one of the known photo count methods, there is a method of counting the pulse currents generated by incident photon onto the photomultiplier or the APD (Avalanche Photo Diode) formed of the monolithic element. In the case where a plurality of incident photons in a short period of time generate the pulse currents a plurality of times, the method cannot count the specific number of times of generation. Therefore, the light quantity cannot be measured with precision, and it has been difficult to apply such method to the defect inspection.

As another photon count method, there has been a known method of measuring the sum of the pulse currents generated by incidence of the photon onto the respective elements of the detector configured to have a plurality of APD elements in 2D (two-dimension) array. The detector may be called Si-PM (Silicon Photomultiplier), PPD (Pixelated Photon Detector) or MPPC (Multi-pixel Photon Counter). Unlike the photon count method using the photomultiplier or the APD formed of the monolithic element, this method allows measurement of the light quantity by summing the pulse currents from the plural APD elements regardless of incidence of the plural photons within the short period of time. In this case, however, the array of the plural APDs is activated as a single detector (“detection ch”). It is therefore difficult to apply this method to the high-speed defect inspection with high sensitivity, which is intended to arrange a plurality of “detection chs” in parallel with one another, and divide the detection view field.

The present invention provides the defect inspection method and the defect inspection device for high-speed detection of the minute defect with high sensitivity by solving the aforementioned problems of related art.

In order to solve the aforementioned problem, the defect inspection method includes the steps of irradiating a linear area of a surface of a specimen placed on a table movable in a plane with an illumination light from a direction inclined with respect to a normal direction of the specimen surface, condensing a scattered light generated from the specimen irradiated with the illumination light through a plurality of detection optical systems including objective lenses disposed in a plane including the normal direction of the specimen surface substantially orthogonal to a longitudinal direction of the linear area of the specimen surface irradiated with the illumination light, detecting the condensed scattered light by a plurality of detectors respectively corresponding to the plurality of detection optical systems, and detecting a defect on the specimen surface by processing a scattered light detection signal derived from detection by the plurality of detectors. The step of condensing includes condensing the scattered light generated from the specimen irradiated with the illumination light through the plurality of optical systems including the objective lens having an aperture angle with respect to the longitudinal direction of the linear area of the specimen surface irradiated with the illumination light, and an aperture angle with respect to a direction substantially orthogonal to the longitudinal direction, both of which being different from each other, and the step of detecting the condensed scattered light includes detecting images with a magnification in the longitudinal direction of the linear area, and a magnification in the direction substantially orthogonal to the longitudinal direction of the linear area, both of which are different from each other with the plurality of detectors with the scattered light condensed by the respective objective lenses of the plurality of optical systems.

In order to solve the aforementioned problem, the invention provides a defect inspection method including the steps of irradiating a linear area of a surface of a specimen placed on a table movable in a plane with an illumination light from a direction inclined with respect to a normal direction of the specimen surface, condensing a scattered light generated from the specimen irradiated with the illumination light through a plurality of detection optical systems including objective lenses disposed in a plane including a normal direction of the specimen surface substantially orthogonal to a longitudinal direction of the linear area of the specimen surface irradiated with the illumination light for detection by a plurality of two-dimensional detectors respectively corresponding to the plurality of detection optical systems, condensing a part of the scattered light generated from the specimen irradiated with the illumination light, which scatters in a direction different from that of the plurality of detection optical systems for detection by a detector with lower sensitivity than that of the two-dimensional detector, and detecting a minute defect on the specimen by processing a signal derived from detection by the plurality of two-dimensional detectors, and a relatively large defect that generates the scattered light to be saturated by the plurality of two-dimensional detectors using a signal derived from detection by the detector with lower sensitivity than that of the two-dimensional detector, and a signal derived from detection by the plurality of two-dimensional detectors.

In order to solve the aforementioned problem, the invention further provides a defect inspection device which includes a table movable in a plane having a specimen placed thereon, an illumination light irradiating section for irradiating a linear area of a surface of the specimen placed on the table with an illumination light from a direction inclined to a normal direction of the specimen surface, a detection optical system section which includes a plurality of detection optical systems disposed in a plane including a normal line of the specimen surface in a direction substantially orthogonal to a longitudinal direction of the linear area of the specimen surface irradiated with the illumination light, each of which has an objective lens for condensing a scattered light generated from the linear area of the specimen surface irradiated with the illumination light from the illumination light irradiating section, and a two-dimensional detector for detecting the scattered light condensed by the objective lens, and a signal processing section which processes a signal derived from detection by the respective two-dimensional detectors of the plurality of detection optical systems of the detection optical system section to detect the defect on the specimen. The objective lens of the detection optical system has an aperture angle in a direction along the longitudinal direction of the linear area of the specimen surface irradiated with the illumination light, and an aperture angle in a direction substantially orthogonal to the longitudinal direction, both of which are different from each other. The detection optical system forms an image on the two-dimensional detector with the scattered light condensed by the objective lens, having a magnification in the longitudinal direction of the linear area different from a magnification in a direction substantially orthogonal to the longitudinal direction of the linear area.

In order to solve the aforementioned problem, the invention provides a defect inspection device which includes a table movable in a plane having a specimen placed thereon, an illumination light irradiating section that irradiates a linear area of a surface of the specimen placed on the table with an illumination light from a direction inclined with respect to a normal direction of the specimen surface, a detection optical system section which includes a plurality of detection optical systems disposed in a plane including a normal line of the specimen surface in a direction substantially orthogonal to a longitudinal direction of a linear area of the specimen surface irradiated with the illumination light, each of which has an objective lens for condensing a scattered light generated from the linear area of the specimen surface irradiated with the illumination light from the illumination light irradiating section, and a two-dimensional detector for detecting the scattered light condensed by the objective lens, and a detector with sensitivity lower than that of the two-dimensional detector for condensing and detecting a part of the scattered light generated from the specimen irradiated with the illumination light, which scatters in a direction different from those of the plurality of detection optical systems, and a signal processing section which detects a minute defect on the specimen by processing a signal derived from detection by the plurality of two-dimensional detectors, and detects a relatively large defect that generates the scattered light to be saturated by the plurality of two-dimensional detectors, using a signal derived from detection by the detector with sensitivity lower than that of the two-dimensional detector and a signal derived from detection by the plurality of two-dimensional detectors.

The present invention is configured as described above to allow detection from a plurality of directions at high NA (numerical aperture ratio), and to effectively detect the scattered light from the minute defect using the parallel type photon count detector for establishing the inspection of high sensitivity.

Combination of the parallel type photon count detector with the generally employed optical sensor allows detection of the defect in the wider dynamic range.

### BRIEF DESCRIPTION OF THE DRAWINGS

FIG. 1 is a block diagram of a basic structure of a defect inspection device according to Example 1 of the present invention.

FIG. 2 is a trihedral view illustrating a configuration of an elliptical lens according to Example 1 of the present invention.

FIG. 3 includes a plan view (upper section) and a front view (lower section), representing arrangement of the elliptical lens of the inspection device according to Example 1 of the present invention.

FIG. 4 is a front view of the elliptical lens constituted as the assembled lens according to Example 1 of the present invention.

FIG. 5A is a plan view of an objective lens constituted as the circular lens as a comparative example of Example 1 of the present invention.

FIG. 5B is a plan view of an objective lens constituted as the elliptical lens according to Example 1 of the present invention.

FIG. 6 is a plan view of a specimen, representing a relationship between a shape of illumination area on the specimen surface and a scanning direction according to Example 1 of the present invention.

FIG. 7 is a plan view of the specimen, representing the track of illumination spot through scanning according to Example 1 of the present invention.

FIG. 8 is a plan view showing a first example of the parallel type photon count sensor according to Example 1 of the present invention.

FIG. 9 is a circuit diagram of an equivalent circuit as an element constituting the parallel type photon count sensor according to Example 1 of the present invention.

FIG. 10 is a block diagram showing a structure of a signal processing section according to Example 1 of the present invention.

FIG. 11A is a side view of another parallel type photon count sensor as a second example according to Example 1 of the present invention.

FIG. 11B is a side view of still another parallel type photon count sensor as a third example according to Example 1 of the present invention.

FIG. 12 is a perspective view representing the first example of the lens configuration of the detection optical system according to Example 1 of the present invention.

FIG. 13A is a side view of the optical system as a second example of the lens configuration that forms the detection optical system according to Example 1 of the present invention.

FIG. 13B is a table representing the relationship between a spot diagram indicating the image forming performance and the visual field height of the lens configuration as the second example of the detection optical system according to Example 1 of the present invention.

FIG. 14A is a side view of the optical system as an example of the lens configuration that forms the detection optical system to which a single-axis image forming system is added according to Example 1 of the present invention.

FIG. 14B is a table representing the relationship between the spot diagram indicating the image forming performance and the visual field height of the exemplary lens configuration that forms the detection optical system to which the single-axis image formation system is added according to Example 1 of the present invention.

FIG. 15A is a block diagram showing the basic structure of the defect inspection device according to Example 2 of the present invention.

FIG. 15B is a front view schematically representing the structure of the detection optical system of the defect inspection device according to Example 2 of the present invention.

FIG. 15C is a block diagram schematically representing the structure of a backscattering light detection unit of the defect inspection device according to Example 2 of the present invention.

### DESCRIPTION OF THE PREFERRED EMBODIMENTS

The present invention provides the defect inspection method and the defect inspection device used for the defect inspection in the process of manufacturing semiconductor devices and the like, which enables detection of the minute defect, high-precision measurement of dimension of the detected defect, non-destructive inspection of the specimen (without changing the quality of the specimen, for example), provision of substantially constant inspection results with respect to the number, position, dimension and the type of the detected defect derived from inspection of the same specimen, and inspection of a large number of specimens within a given period of time.

Embodiments of the present invention will be described referring to the drawings. It is noted that the invention is not limited to the embodiments as described above, and may include various modifications. The following embodiments will be described in detail for the purpose of easy understanding of the present invention, and are not necessarily restricted to the one provided with all the structures of the description. The structure of any one of the embodiments may be partially replaced with that of the other embodiment. Alternatively, it is possible to add the structure of any one of the embodiments to that of the other embodiment. It is also possible to have the part of the structure of the respective embodiments added to, removed from and replaced with the other structure.

### Example 1

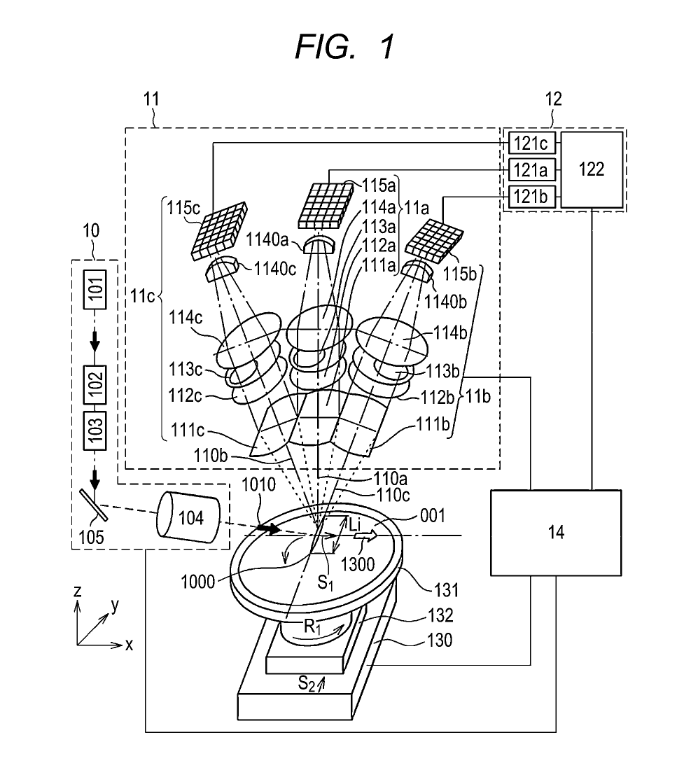

FIG. 1 illustrates an exemplary structure of the defect inspection device according to the embodiment. The defect inspection device of this embodiment includes an illumination optical system unit 10, a detection optical system unit 11, a signal processing unit 12, a stage unit 13, and an overall control unit 14.

The illumination optical system unit 10 includes a light source 101, a polarization state control unit 102, a beam forming unit 103, and a thin linear light condensing optical system 104. In the aforementioned structure, the illumination light emitted from the light source 101 transmits through the polarization state control unit 102 and the beam forming unit 103, and is introduced into the thin linear light condensing optical system 104 while having the optical path changed by a mirror 105. In this case, the polarization state control unit 102 is formed of the polarizer such as the half-wave plate and quarterwave plate, and provided with the drive unit (not shown) for rotation around the optical axis of the illumination optical system. The unit serves to adjust the polarized state of the illumination light for illuminating the wafer 001 placed on the stage unit 13.

The beam forming unit 103 is an optical unit for forming the thin linear illumination as described below, which consists of a beam expander, anamorphic prism and the like.

The thin linear light condensing optical system 104 is composed of the cylindrical lens and the like, and illuminates a thin linear illumination area 1000 of a wafer (substrate) 001 with the illumination light shaped into the thin line. This embodiment will be described on the assumption that the width direction of the thin linear illumination area (substantially orthogonal to the longitudinal direction of the thin linear illumination area 1000: direction of arrow 1300) is defined as the stage scanning direction (x-direction), and the longitudinal direction of the thin linear illumination area 1000 is defined as the y-direction as shown in FIG. 1.

This embodiment is configured to allow the narrowed thin linear illumination to the illumination area 1000, as one of aims to improve the inspection throughput by intensifying illuminance of lighting (increasing the energy density of lighting) to the inspection subject. It is preferable to use the laser light source, that is, the high coherent light source with good light condensing property for emitting the linearly polarized light as the light source 101. As described in the background, it is effective to shorten the wavelength of the light source in order to increase scattered light from the defect. This embodiment is configured to use UV (Ultra Violet) laser as the light source 101. It may use the 355 nm solid-state laser of YAG (Yttrium Aluminum Garnet)-THG (third harmonic generation), 266 nm solid-state laser of YAG-FHG (Fourth harmonic generation), or any one of 213 nm, 199 nm and 193 nm solid-state lasers derived from sum frequency of YAG-FHG and YAG fundamental waves.

The scattered light from the wafer 001 exposed to radiation of the thin linear light from the illumination optical system unit 10 is detected through the detection optical system unit 11. The detection optical system unit 11 includes three detection units 11a to 11c. This embodiment takes the detection optical system 11 including the three detection units as an example. However, the detection optical system may be composed of two detection units, or four or more detection units. A suffix “a” is added to each code of the elements constituting the first detection unit 11a, suffix “b” is added to each code of the elements constituting the second detection unit 11b, and suffix “c” is added to each code of the elements constituting the third detection unit 11c for the purpose of distinguishing the elements.

The first detection unit 11a includes an objective lens 111a, a spatial filter 112a, a polarizing filter 113a, an image forming lens 114a, a single-axis image forming system (for example, cylindrical lens) 1140a, and a parallel type photon count sensor 115a. Each of the second detection units 11b and the third detection unit 11c has the same optical elements as described above. In the first detection unit 11a, the scattered light from the wafer 001 exposed to the thin linear radiation by the illumination optical system unit 10 is condensed by the objective lens 111a so that the scattered light image (dot image) of the defect on the wafer 001 is formed by the image forming lens 114a and the single-axis image forming system 1140a over a plurality of elements on the parallel type photon count sensor 115a. Similarly, the light is condensed by the respective objective lenses 111b and 11c, respectively in the case of the second detection unit 11b and the third detection unit 11c. Then the scattered light images (dot images) of the defect on the wafer are formed by the image forming lenses 114b, 114c, and the single-axis image forming systems 1140b, 1140c over a plurality of elements of the parallel type photon count sensors 115b and 115c, respectively. Referring to FIG. 1, each of the objective lenses 111a, 111b, 111c is formed by linearly cutting the right and left sides of the circular lens to form the laterally symmetric elliptical lens. The structure and resultant effect will be described in detail.

Aperture control filters 112a, 112b, 112c of the detection optical system unit 11 serve to shield the background scattered light generated by roughness of the substrate surface so as to improve the defect detection sensitivity by reducing the background light noise during detection. Each of the polarizing filters (polarizing plates) 113a, 113b, 113c filters the specific polarizing component from the scattered light to be detected to improve the defect detection sensitivity by reducing the background light noise. Each of the parallel type photon count sensors 115a, 115b, 115c serves to convert the detected scattered light into the electric signal through the photoelectric conversion. There is the known method of measuring the total pulse currents generated through incidence of the photon onto the respective elements of the detector formed by arranging a plurality of APD elements in the 2D (two-dimensional) array. This type of detector is the one called as Si-PM (Silicon Photonmultiplier), PPD (Pixelated Photon Detector), or MPPC (Multi-Pixel Photon Counter).

FIG. 8 shows an exemplary structure of a light receiving surface of the parallel type photon count sensor 115a. The parallel type photon count sensor 115a is configured by two-dimensionally arraying a plurality of monolithic APD elements 231. Each of the APD elements 231 receives application of voltage so as to be operated in Geiger mode (photoelectron magnification ratio: 10⁵ or higher). Upon incidence of one photon onto the APD element 231, a photoelectron is generated in the APD element with the probability corresponding to the quantum efficiency of the APD element, and multiplied under the effect of the APD in Geiger mode. The pulse-like electric signal is then output. It is assumed that a group of APD elements 231 enclosed by a dotted line 232 is classified as one unit (ch) so that the respective pulse-like electric signals generated in the APD elements (i units in S1-direction by j units in S2-direction) are summed and output. The resultant total signal by the summing corresponds to the light quantity detected through photon counting. Plural chs are arrayed in the S2-direction so that each scattered light image of a plurality of area divided in the longitudinal direction of the area illuminated with the thin linear light in the field of view in the detection system is enlarged and projected at the positions corresponding to those chs arrayed in the S1-direction. This makes it possible to detect quantity of the scattered light through the parallel photon count process to each of the plural area in the field of view of the detection system. The scattered light detection by counting photons makes it possible to detect the feeble light. It is therefore possible to detect the minute defect or improve the defect detection sensitivity.

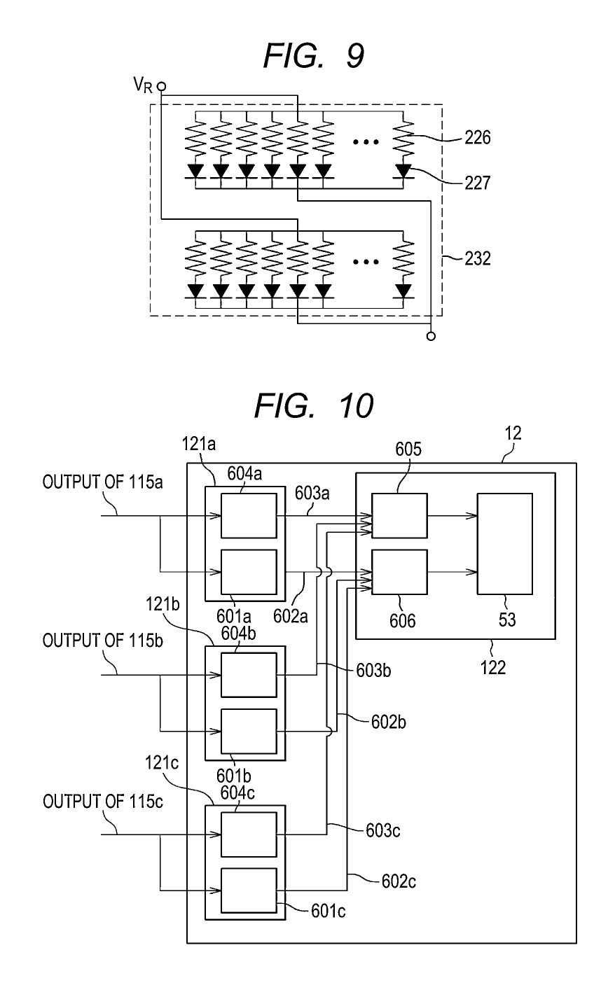

FIG. 9 shows a diagram of the circuit equivalent to the group of I×j APD elements for constituting 1 ch. A pair of a quenching resistance 226 and an APD 227 in the drawing corresponds to the single APD element 231 as described referring to FIG. 8. A reverse voltage V_{R} is applied to each of the APDs 227. Setting of the reverse voltage V_{R} to be equal to or higher than the breakdown voltage of the APD 227 allows its operation in Geiger mode. The circuit configuration as shown in FIG. 9 provides the output electric signal (peak value of voltage, current, or electric charge) proportional to the total number of incident photons onto the region of 1 ch of the parallel type photon count sensor including the group of I×j APD elements. The output electric signals corresponding to the respective chs are subjected to analog-digital conversion, and output as time series digital signals in parallel.

Even if a plurality of photons are incident within a short period of time, the APD element outputs the pulse signal at substantially the same level as the one derived from the state where only one photon is incident. When the number of the incident photons per unit time onto the respective APD elements is increased, the total output signal of the single ch is no longer proportional to the number of incident photons, thus deteriorating the linearity of the signal. When quantity of incident light onto all the APD elements of the single ch is equal to or higher than a given value (approximately one photon per one element on an average), the output signal is saturated. A large number of APD elements are arrayed in the S1- and S2-directions so that the image of the scattered light projected on the light receiving surface of the parallel type photon count sensor 115 through the single-axis image forming systems 1140a to 1140c is enlarged to be projected on those APD elements of the single ch. This configuration allows reduction in incident light quantity for each pixel, thus ensuring more accurate photon counting. For example, assuming that the number of pixels of 1 ch having I×j elements arrayed in the S1- and S2-directions is set to 1000, if the quantum efficiency of the APD element is 30%, the light intensity equal to or less than 1000 photons per unit time upon detection ensures sufficient linearity. It is therefore possible to detect the light intensity equal to or less than approximately 3300 photons without saturation.

The parallel type photon count sensor shown in FIG. 8 exhibits uneven light intensity in the S1-direction, that is, the light intensity at the end part of the sensor is weaker than the one at the center part. Use of the lenticular lens having a large number of minute cylindrical lenses each with curvature in the S1-direction arrayed, the diffraction type optical element, or the aspherical lens instead of the cylindrical lens allows the single-axis enlarged image 225 of the defect image in the S1-direction to be distributed with even intensity. This makes it possible to further expand the light intensity range which ensures linearity, or the light intensity range with no saturation while retaining the number of APD elements in the S1-direction.

The thin linear illumination area 1000 as described above serves to illuminate the substrate so as to be narrowed to the detection range of the parallel type photon count sensor 115 for improving the illumination light efficiency (illuminating the region outside the sensor detection range is ineffective).

The detection optical system 11 according to this embodiment has three detection units 11a, 11b, 11c, each of which has the same structure. This is because that by arranging a plurality of the same structures at a plurality of locations, it makes possible to reduce the manufacturing steps and manufacturing costs of the inspection device.

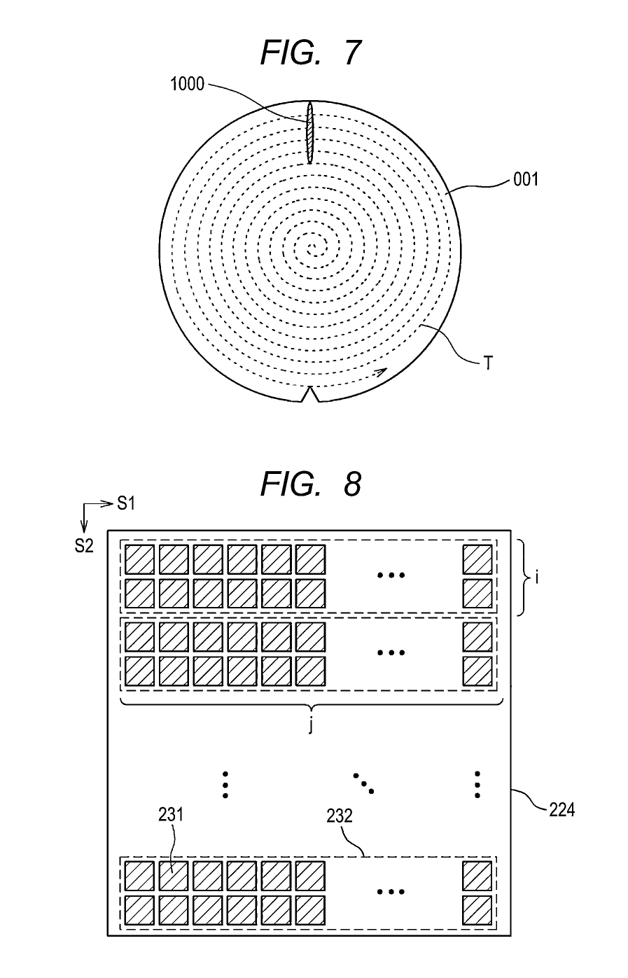

The stage unit 13 includes a translation stage 130, a rotary stage 131, and a Z stage 132 for adjusting the height of the wafer surface. The method of operating the wafer surface by the stage unit 13 will be described referring to FIGS. 6 and 7.

It is assumed that the longitudinal direction of the thin linear illumination area 1000 on the surface of the wafer 001 shown in FIG. 6 formed by the wafer illumination optical system unit 10 is set to S2, and the direction substantially orthogonal to the S2-direction is set to S1. Rotating motion of the rotary stage scans in the circumferential direction R1 of the circle having the rotary axis of the rotary stage as the center. The parallel movement of the translation stage scans in the parallel direction S2 of the translation stage. In the single rotation of the specimen by the scanning (toward the S1-direction as the tangential direction of the circumference in the thin linear illumination area 1000) in the circumferential direction R1, the scan is performed for the distance that is equal to or shorter than the longitudinal length of the thin linear illumination area 1000 toward the scanning direction S2. Then as FIG. 7 shows, the illumination spot (thin linear illumination area 1000) forms the spiral track T on the wafer 001. This scanning is performed for the length derived from adding the length of the thin linear illumination area 1000 to the radius of the wafer 001 so that the entire surface of the wafer 001 is scanned. This makes it possible to inspect the entire surface of the wafer.

The relationship among the length of the illumination area 1000, the optical magnification of the detection optical system unit 11, and the dimension of the parallel type photon count sensor 115 will be described. The length Li of the illumination area 1000 is set to approximately 200 μm for the purpose of conducting the high-speed inspection with high sensitivity. Assuming that 20 APD elements (25 μm×25 μm) operated in Geiger mode are arranged in the S2-direction, and 160 APD elements are arranged in the S1-direction to constitute the 1ch, and 8chs are arranged in the S2-direction to configure the parallel type photon count sensor 115, the whole length of the resultant parallel type photon count sensor 115 in the S1-direction is 4 mm. The optical magnification of the detection section becomes 20 times as high as that of the case where the illumination area has the length Li of 200 μm, and the pitch of the detection ch projected on the wafer becomes 25 μm.

Under the aforementioned condition, the specimen is rotated at the rotating speed of 2000 rpm, and the feed pitch of the translation stage for each rotation is set to 12.5 μm, the wafer with diameter of 30 mm has its entire surface scanned in 6 seconds, and the wafer with diameter of 450 mm has its entire surface scanned in 9 seconds. In the aforementioned case, the feed pitch of the translation stage for each rotation upon rotary scanning of the wafer is half the pitch 25 μm of the detection ch projected on the wafer surface. However, it is not limited to the aforementioned value. The value may be set to an arbitrary value without being limited to 1/even numbered, 1/odd numbered, or 1/integer numbered of the pitch of the detection ch projected on the wafer surface.

The signal processing unit 12 classifies various defect types and estimates the defect dimension with high precision based on the scattered light signals which have been photoelectric converted through the first, the second, and the third parallel type photon count sensors 115a, 115b, and 115c. The specific configuration of the signal processing unit 12 will be described referring to FIG. 10. The signal processing unit 12 includes filtering processing sections 121a, 121b, 121c, and a signal processing-control section 122. Actually, the signal processing unit 12 is configured that each of the detection units 11a, 11b, 11c outputs a plurality of signals for each ch of the parallel type photon detection sensors 115a, 115b, 115c, respectively. The explanation will be made with respect to the signal of one ch of those described above. The similar process is conducted for the other ch in parallel.

The output signals corresponding to the detected scattered light quantity from the parallel type photon count sensors 115a, 115b, 115c of the detection units 11a, 11b, 11c are subjected to the process of extracting defect signals 603a, 603b, 603c by high-pass filters 604a, 604b, 604c in the filtering processing sections 121a, 121b, 121c, respectively. Those signals are then input to a defect determination section 605. The stage scanning is performed in the width direction (circumferential direction of wafer) S1 of the illumination area 1000. The waveform of the defect signal is derived from expanding or shrinking the illuminance distribution profile in the S1-direction of the illumination area 1000. Therefore, the respective high-pass filters 604a, 604b, 604c serve to cut the frequency band and direct-current component containing noise to a relatively great extent through the frequency band which contains the defect signal waveform so as to improve each S/N of the defect signals 603a, 603b, 603c.

Each of the respective high-pass filters 604a, 604b, 604c is formed by the use of any one of the filter selected from the high-pass filter with specific cut-off frequency, which is designed to shield the component equivalent to or higher than the cut-off frequency component, the band-pass filter, and an FIR (Finite Impulse Response) filter having the similar waveform to that of the defect signal, which reflects the illuminance distribution shape of the illumination area 1000.

The defect determination section 605 of the signal processing-control unit 122 executes the threshold process to each input signal including the defect waveform output from the high-pass filters 604a, 604b, 604c so that it is determined whether the defect exists. In other words, the defect determination section 605 receives the defect signal based on the detection signals from a plurality of detection optical systems. The defect determination section 605 is allowed to conduct the defect inspection with sensitivity higher than the one based on the single defect signal by executing the threshold process to the sum or weighted average of a plurality of defect signals, or taking OR, AND on the same coordinate system set on the wafer surface for the defect group extracted from the defect signals through the plural threshold process.

The defect determination section 605 provides a control section 53 with defect information including the defect coordinates indicating the defect position in the wafer, and an estimated value of the defect dimension, both of which are calculated based on the defect waveform and the sensitivity information signal at the location determined as existing the defect so that the defect information is output to the display section. The defect coordinates are calculated on the basis of the center of gravity of the defect waveform. The defect dimension is calculated based on the integrated value or the maximum value of the defect waveform.

The signals output from the parallel type photon count sensors 115a, 115b, 115c are input to low-pass filters 601a, 601b, 601c in addition to the high-pass filters 604a, 604b, 604c constituting the filtering processing sections 121a, 121b, 121c, respectively. Each of the low-pass filters 601a, 601b, 601c outputs the low frequency component and the direct-current component corresponding to the scattered light quantity (haze) from the minute roughness of the illumination area 1000 on the wafer.

Output signals 602a, 602b, 602c from the low-pass filters 601a, 601b, 601c are input to a haze processing section 606 of the signal processing-control section 122 for processing the haze information. In other words, the haze processing section 606 outputs the signal as a haze signal corresponding to the size of the haze for each point on the wafer 001 in accordance with the values of the input signals 602a, 602b, 602c derived from the respective low-pass filters 601a, 601b, 601c.

The angular distribution of the scattered light quantity from the minute roughness varies with its spatial frequency distribution. The haze processing section 606 receives inputs of the haze signals 602a, 602b, 602c as output signals from a plurality of the detection systems 11a, 11b, 11c which are disposed in the different dimensions so as to provide the information concerning the spatial frequency distribution of the minute roughness in accordance with the strength ratio of the signals. The information derived from the haze signals is processed to provide the information on the wafer surface state.

The overall control unit 14 controls the illumination optical system unit 10, the detection optical system unit 11, the signal processing unit 12 and the stage unit 13.

If the wafer deviates from the focusing range of the detection optical system 11 during scanning, the state of the feeble scattered light detected by the parallel type photon count sensors 115a, 115b, 115c changes to deteriorate the defect detection sensitivity. For the purpose of preventing the deterioration, the Z stage (not shown) serves to control so that the z position (position in the height direction) on the surface of the wafer 001 is constantly in the focusing range of the detection optical system unit 11 during scanning. A z position detection unit (not shown) on the wafer 001 serves to detect the z position on the surface of the wafer 001.

Defocusing of the surface of the wafer gives a significant impact on the state of the scattered light image of the defect formed on the parallel type photon count sensors 115a, 115b, 115c, which may cause substantial deterioration in the defect detection sensitivity. In order to avoid the deterioration, the illumination optical system unit 10 and the detection optical system unit 11 according to the embodiment are configured to be described below. The respective detection units 11a, 11b, 11c of the detection optical system unit 11, each of which has the same structure, have respective optical axes 110a, 110b, 110c. Those axes are disposed in the same plane (hereinafter referred to as the detection optical axial surface) at different detection elevation angles. The detection optical axial surface is set to be substantially orthogonal to the plane defined by the normal line of the surface of the wafer 001 on the inspection object (z-direction) and the longitudinal direction of the thin linear illumination area 1000 (y-direction: S2-direction). The optical axes 110a, 110b, 110c of the detection unit, and an optical axis 1010 of the illumination optical system intersect with one another at substantially a single point.

In the case where the detection optical systems 11a, 11b, 11c each with the same structure are disposed to detect the scattered light from different directions, the aforementioned configuration ensures to keep the constant distance between the respective points in the detection range on the inspection surface, which are detected by the parallel type photon count sensors 115a, 115b, 115c of the detection optical system unit 11 and the respective detection surfaces of the sensors 115a, 115b, 115c. It is therefore possible to detect the scattered light in focus over the entire surfaces of the detection regions of the parallel type photon count sensors 115a, 115b, 115c without providing a special structure for the detection.

As described above, the laterally symmetric elliptical lens formed by linearly cutting the right and left sides of the circular lens is used as the objective lenses 111a, 111b, 111c. The linear part which has been cut out is disposed to be vertical to the detection optical axial surface as described above. Compared with the case where the generally employed circular lens is used, in the aforementioned case of disposing a plurality of detection units, it is possible to improve the scattered light capturing efficiency by enlarging the detection aperture and to provide the scattered light over the entire surface of the regions of the parallel type photon count sensors 115a, 115b, 115c in focus. And it also makes possible to detect the scattered light in the focused state over the entire surface of the regions detected by the photon count sensors 115a, 115b, 115c. The optical system is made symmetric with respect to the plane defined by the longitudinal directions of the photon count sensors 115a, 115b, 115c, and the optical axes of the detection units 11a, 11b, 11c so as to allow the detected scattered light to be equalized over the entire surface of the regions detected by the photon count sensors 115a, 115b, 115c. The photons of the scattered light from the specimen surface are counted in parallel to improve the defect detection sensitivity as well as the inspection throughput.

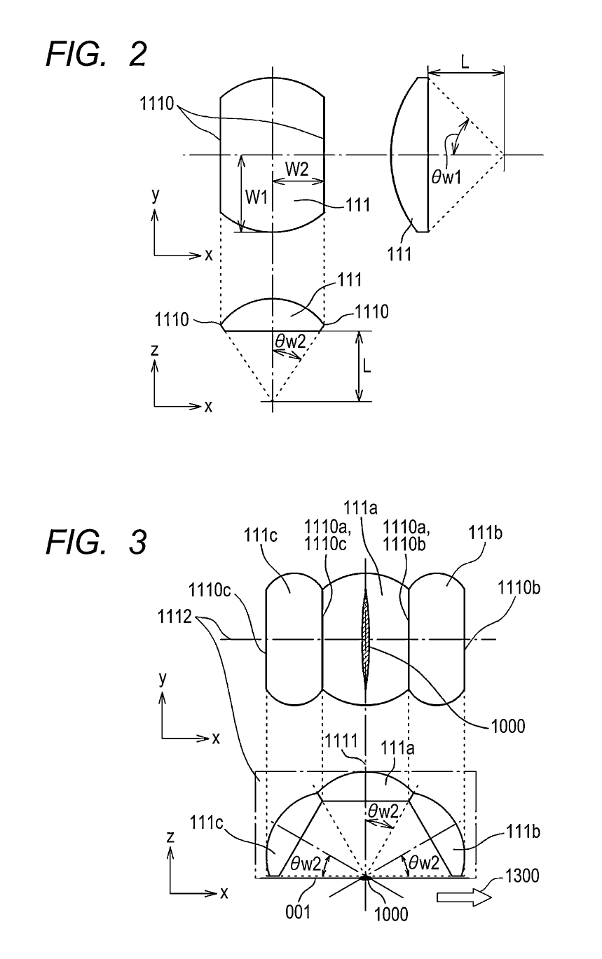

The structure of the elliptical lens of the embodiment will be described referring to FIGS. 2 to 5B. FIG. 2 is a trihedral view of the elliptical lens for explaining the single lens shape of the elliptical lens 111. The upper left part, the right part, and the lower part represent a plan view, a side view and a front view of the elliptical lens 111, respectively. The planar shape of the elliptical lens 111 is formed by cutting the right and left sides of the circular lens along two linear cut planes 1110 so as to be almost laterally symmetric as illustrated by the plan view of the upper left part of FIG. 2. Assuming that the detection aperture angle (short side direction) is set to θw2 for forming the assembled lens by combining the single lenses, and the distance from the focal plane of the lens is set to L as shown in the lower part of FIG. 2, the front part is formed by diagonally cutting to establish the relationship of the lens half width W2≈L·tan θw2. The detection aperture of the lens at the aperture angle θw1 in the y-direction as illustrated in the side view as the right part becomes different from that of the lens at the aperture angle θw2 in the x-direction as illustrated in the front view as the lower part to establish the relationship of θw1>θw2. Arrangement of the lenses in the actual device will be described below.

FIG. 3 is an explanatory view illustrating that the above-described elliptical lens 111 is arranged on the inspection device. The upper part and the lower part of FIG. 3 represent a plan view and a front view, respectively. Referring to the plan view (in xy-plane) as the upper part of FIG. 3, each of three elliptical objective lenses 111a, 111b, 111c has the same aperture. Each optical axis of the objective lenses 111b and 111c is inclined, which is shown as the view seen in the xy-plane. Those lenses appear to be smaller than the objective lens 111a. The three elliptical objective lenses 111a, 111b, 111c are disposed so that the respective focal points are in alignment with the position of the thin linear illumination area 1000 on the surface of the wafer 0001. In this case, the optical axes of the elliptical objective lenses 111a, 111b, 111c are disposed in the same plane of the detection optical axial surface 1112 so as to be substantially vertical to the surface defined by the normal line 1111 to the surface of the wafer 001 and the longitudinal direction (y-axis direction) of the thin linear illumination area 1000. Additionally, those optical axes are symmetrically arranged to the normal line 1111 as the center with respect to the surface of the wafer 001. Lens cut surfaces 1110a, 1110b, 1110c are arranged parallel to one another as close as possible. The lens cut surfaces 1110a, 1110b, 1110c are directed parallel to the longitudinal direction of the thin linear illumination area 1000 so that the wafer is scanned in a direction 1300 at right angles to this direction during the inspection. The lens detection aperture is set to θw2 in the x-direction, and to θw1 in the y-direction. Referring only to the single lens, the aperture size has the relationship of x-direction<y-direction. Combining the plural lenses 111a, 111b, 111c may enlarge the aperture as a whole in the x-direction.

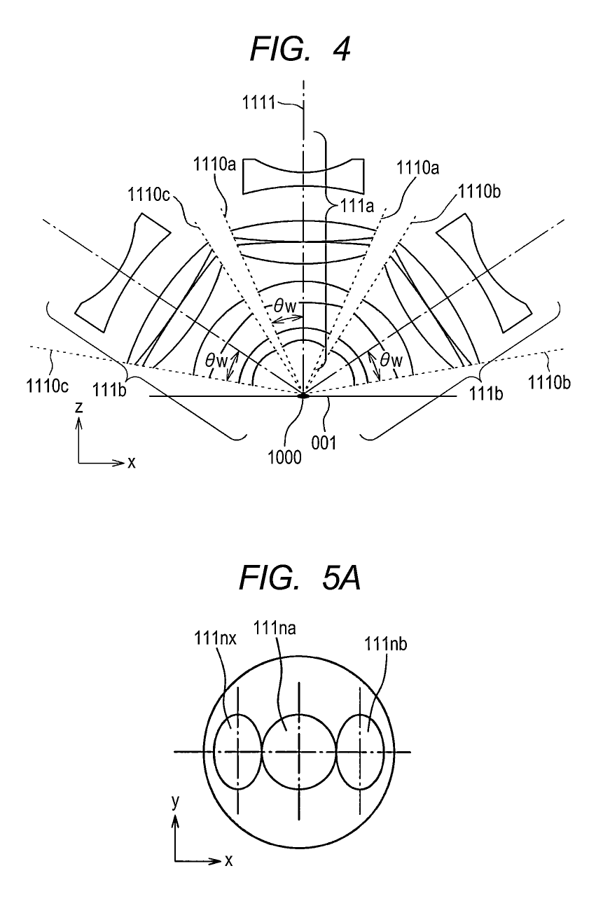

FIG. 4 is an explanatory view of the embodiment configured on the assumption that the actual objective lens is the assembled lens formed by combining a plurality of single lenses into the elliptical lens. Referring to FIG. 4, each of the objective lenses 111a, 111b, 111c includes five assembled lenses. In this case, all the lenses are not necessarily formed as the elliptical lenses. As the distance from the wafer 001 is increased, the distance between the optical axes of the lenses is also elongated. Therefore, the elliptical lens may be used for forming the part which is expected to cause interference between the circular lenses.

As interference occurs between the circular lenses, the embodiment is configured to use four elliptical lenses close to the wafer. Basically, the cut state is the same as the one described referring to FIG. 2. In other words, each tip of the four lenses of those objective lenses 111a, 111b, 111c are cut along the cut surfaces 1110a, 1110b, 1110c to form the detection aperture angle θw. The lens at the back side is not cut because of no interference between the lenses.

As described referring to FIG. 3, three objective lenses 111a, 111b, 111c are disposed to adjust the focus to the position of the thin linear illumination area 1000. In this case, optical axes of the objective lenses 111a, 111b, 111c are disposed in the same plane (corresponding to the detection optical axial surface 1112) substantially vertical to the surface defined by the normal line 1111 to the surface of the wafer 001 and the longitudinal direction of the thin linear illumination area 1000 (y-axis direction, not shown). Additionally, those optical axes are arranged to be symmetrical with respect to the normal line to the surface of the wafer 001. The lens cut surfaces 1110a, 1110b, 1110c are disposed as close as possible in parallel with one another.

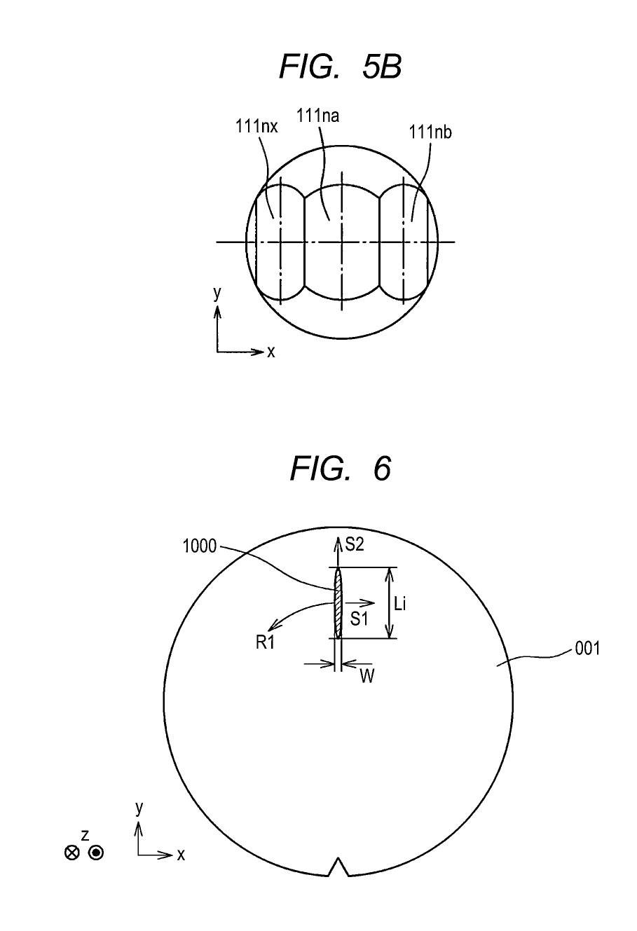

FIGS. 5A and 5B are explanatory views with respect to the advantage of using the elliptical lens. FIG. 5A illustrates the aperture for detection executed by the same circular lenses 111na, 111nb, 111nc from three different detection directions. Each aperture of the lenses has the circular shape with the same size. The optical axes of the objective lenses 111nb and 111nc are inclined, which are seen from the xy-plane as shown in the drawing. Therefore, those lenses appear to be smaller than the objective lens 111na.

In this case, the lens aperture has to be made small in size for avoiding the lens interference. Because of the circular shape, the aperture has to be made small both in the x-direction and the y-direction. In this embodiment, it is assumed that the wafer image is formed through the image forming optical system as the detection optical system. For this, optical axes of a plurality of objective lenses are expected to be disposed in the same plane as the condition. If the circular lenses are disposed on the assumption as described above, the aperture for detection is significantly limited. Especially, there may be a disadvantage that the detection aperture in the y-direction becomes small. Meanwhile, the elliptical lenses 111a, 111b, 111c are used so that the apertures of the respective objective lenses are arbitrarily set in the x-direction and the y-direction as shown in FIG. 5B. The aperture of the single objective lens is made small only in the x-direction where the lens interference occurs by providing the required number of the lenses. The aperture in the y-direction may be set to have the required size irrespective of the aperture in the x-direction. In the state where the image detection is executed through a plurality of detection optical systems, the detection efficiency of the feeble scattered light from the defect is improved to ensure higher defect detection sensitivity compared with the use of the circular lens.

In the aforementioned embodiment, three detection units 11a to 11c of the detection optical system unit 11, each of which includes the optical system with the same structure as an example. The present invention is not limited to the aforementioned example. The objective lens 111a of the first inspection unit 11a may be larger than the objective lenses 111b and 111c of the second and the third detection units 11b and 11c so that the objective lens 111a of the first inspection unit 11a condenses more scattered light in the direction vertical to the wafer 001 and its vicinity region for forming the image. The thus configured detection optical system makes it possible to increase NA of the first inspection unit 11a, thus allowing the first inspection unit 11a to detect further minute defect.

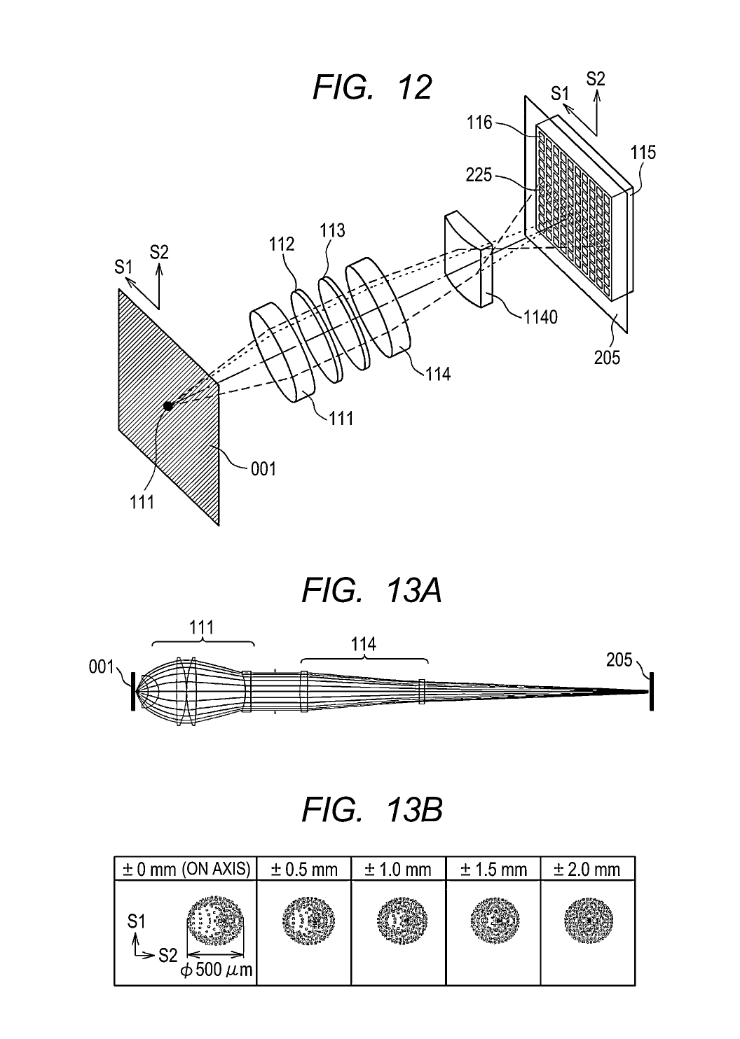

FIG. 12 illustrates the objective lens 111, the control aperture filter 112, the polarizing filter 113, the image forming lens 114, the single-axis image forming system 1140, and the parallel type photon count sensor 115 of the detection optical system unit 11 (Each of three detection units 11a, 11b, 11c of the detection optical system unit 11 has the same structure, and therefore, the suffix added to each code of the components will be omitted.). The scattered light image (point image) of the defect 111 on the wafer 001 is formed onto a specimen surface conjugate plane 205 conjugating with the wafer surface through the image forming optical system composed of the objective lens 111 and the image forming lens 114. In this case, the scattered light image of the defect is formed as an image 225 which is extended by the single-axis image forming system 1140 in the single axial direction (S1-direction). The parallel type photon count sensor 115 is disposed to have the sensor surface substantially flush with the specimen surface conjugate plane. As a result, the scattered light image of the defect is formed in the S1-direction to cover a plurality of APD elements 116 (corresponding to the APD elements 231 shown in FIG. 8) on the parallel type photon count sensor 115.

The single-axis image forming system 1140 serves to condense the light only in the direction corresponding to the circumferential scanning direction (circumferential tangent direction) S1, and includes an anamorphic optical element such as the cylindrical lens. The function of the single-axis image forming system 1140 expands the scattered light image 225 of the defect formed on the specimen conjugate plane 205, that is, the surface of the parallel type photon count sensor 115 in the direction corresponding to the circumferential scanning direction S1. Meanwhile, the single-axis image forming system 1140 does not affect the image formation in the S2-direction at right angles to the S1-direction. The size of the image formed on the specimen surface conjugate plane 205 in the S2-direction is determined under the condition of the image forming lens 114. That is, the scattered light image 225 of the defect formed on the specimen conjugate plane 205 becomes an image with the magnification ratio that differs between directions S1 and S2.

It is assumed that the minute defect to be detected is smaller than the wavelength of the illumination light, the size of the defect image (spot image) on the specimen conjugate plane 205 is determined by the optical resolution values of the objective lens 111 and the image forming lens 114. Generally, the “aberration-free optical system” as the high-precision optical system is defined as the one having the wavefront aberration of 0.1× or less (Strehl ratio: 0.8 or higher), represented by the lens for microscope. In the above-structured system, the image size W is determined by the following formula 1 based on Rayleigh's image forming theory by setting the NA (Numerical Aperture) of the objective lens to NA₀, magnification of the image forming optical system including the objective lens 111 and the image forming lens 114 to M, and the wavelength of the illumination light source to λ.

W=1.22×λ/(NA₀/M) (numerical formula 1)

In the aforementioned condition where λ=0.355 (μm), NA₀=0.8, and M=20(times), the value of 10.8 μm is obtained as the size W of the defect image in the S2-direction of the scattered light image 225 of the defect formed on the specimen conjugate plane 205, that is, the surface of the parallel type photon count sensor 115, which is not extended by the single-axis image formation system. This value is unnecessarily smaller than 25 μm as the size of the APD element 116 (231) of the parallel type photon count sensor 115 described as the embodiment, or 500 μm (corresponding to 20 elements) as the width of 1ch of the parallel type photon count sensor 115 in the S2-direction.

Based on the principle of the light quantity measurement by the photon count sensor, the defect size of the scattered light image 225 in the S2-direction as the parallel scanning direction has to be expanded to 500 μm corresponding to the width in the S2-direction as the parallel scanning direction of 1ch (corresponding to 20 elements). On the assumption that the aberration-free optical system is employed, the surface of the parallel type photon count sensor 115 is disposed at the position apart from the specimen conjugate plane 205, and the focal point is deviated from the sensor surface so as to expand the scattered light image. The aberration-free optical system requires increased number of the lenses for aberration correction. Use of the high-precision optical system while deliberately shifting the focus implies that there is no need of using such high-precision optical system. This may unnecessarily increase the optical system cost.

The image forming optical system according to the embodiment, there is no need of using an aberration-free optical system and it allows the aberration to a certain extent. The embodiment may be configured to form the scattered light image of the defect on the conjugate plane 205 so long as its size is 46 times (500 μm) as large as that of the spot image (10.8 μm) calculated from Rayleigh's image forming theory. Mitigation of the aberration condition of the optical system as described above provides advantages, compared with use of the aberration free optical system, of reducing the number of the objective lenses 111 and the image forming lenses 114 to ensure mitigation of conditions for work precision and assembly precision, and conducting the inspection with high sensitivity using the low-cost optical system.

Meanwhile, the parallel type photon count sensor 115 according to the embodiment has 160 APD elements 116 (231) arranged for each ch to have a full length of 4 mm in the S1-direction corresponding to the circumferential tangential direction. In this case, the single-axis image forming system 1140 serves to extend the scattered light image of the defect to have the same length or shorter than that of the parallel type photon count sensor 115 in the S1-direction.

The above-structured optical system forms the scattered light image of the defect so as to be adaptable to the size of 1 ch of the parallel type photon count sensor 115. Then it is possible to measure the light quantity by counting photons of the scattered light from the defect in the required dynamic range (corresponding to the number of APD elements for detecting the scattered light from defect=the number of the APD elements in the range of the scattered light image from defect).

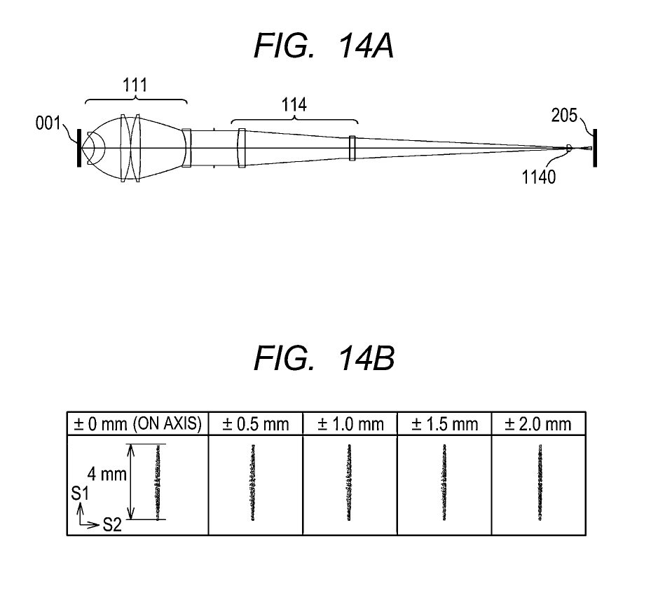

An embodiment of structures of the objective lens 111 and the image forming lens 114, which constitute the detection optical system 11 will be described referring to FIGS. 13A, 13B, 14A and 14B.

FIG. 13A shows an overall system of the lens that constitutes the detection optical system (image forming optical system) 11. The drawing shows the structure in the state where the lens is not cut. The code 111 denotes the objective lens, and the code 114 denotes the image forming lens. The objective lens includes four lenses, and the image forming lens includes two lenses. It is assumed that the NA of the objective lens is set to 0.8, and the magnification is set to 20, as well as the wavelength in use set to 355 nm. Use of the objective lens with high NA of 0.8 allows efficient detection of the scattered light generated from the defect on the wafer in the wide range.

FIG. 13B is a spot diagram showing the image forming performance of the detection optical system (image forming optical system) shown in FIG. 13A. Referring to the upper column of FIG. 13B represents the visual field height, setting the state where the surface of the wafer 001 is focused to +/−0 mm. The lower column of FIG. 13B represents images observed at the respective visual field heights. The drawing shows the state where the scattered light from the point on the wafer surface is formed on the sensor surface, and the spot images each with diameter of approximately 500 μm are uniformly formed on the entire region in the visual field. As described above, the aberration-free optical system such as the image forming optical system for microscope is capable of providing the spot diagram of 10.8 μm. On the contrary, the detection optical system according to the present embodiment does not require such a high aberration performance (resolution). It is therefore possible to configure the high NA optical system using significantly small number of lenses.

FIG. 14A shows the structure formed by adding the single-axis image forming system 1140 to the detection optical system shown in FIG. 13A. Specifically, the cylindrical lens is disposed between the image forming lens and the sensor surface. FIG. 14B is a spot diagram showing the image obtained by extending the scattered light image shown in FIG. 13B with the single-axis image forming system 1140. The upper column of FIG. 14B represents the visual field height, setting the state where the surface of the wafer 001 is focused to +/−0 mm. The lower column of FIG. 14B represents images observed at the respective visual field heights. Each image is extended along the S1-direction by a length of 4 mm in the entire region of the visual field. The above-structured optical system allows the scattered light from the defect to be incident onto the respective elements of the chs of the parallel type photon count sensor uniformly, thus enabling the defect detection by counting photons.

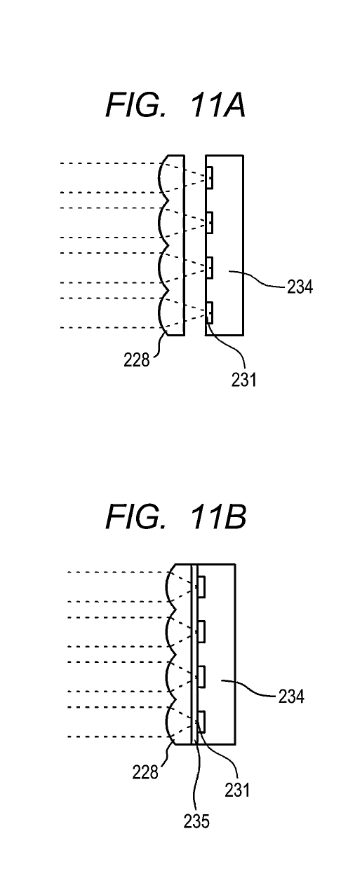

FIGS. 11A and 11B show Modified Example 1 of the structure of a parallel type photon count sensor 224. Referring to the parallel type photon count sensor 224 having the APD elements arrayed, if the respective APD elements are made small, the area of the neutral zone including wiring disposed between the APD elements, and quenching resistance becomes relatively large with respect to the effective area of the light receiving section. Then the aperture ratio of the parallel type photon count sensor is lowered, thus causing the problem of reducing photo-detection efficiency. By disposing a micro lens array 228 in front of the light receiving surface of the parallel type photon count sensor 234, it is possible to reduce the rate of the incident light onto the neutral zone between the elements as shown in FIG. 11A. This makes it possible to improve the practical efficiency. The micro lens array 228 includes minute convex lenses arranged at the same pitch as the array pitch of the APD elements 231, and is disposed so that the light ray parallel to the main optical axis of the incident light onto the parallel type photon count sensor 234 (indicated by the dotted line shown in FIG. 11A) is incident onto the point around the center of the light receiving surface of the corresponding APD element 231.

FIG. 11B shows Modified Example 2 of the structure of the parallel type photon count sensor 224. Generally, silicon-based material is used for forming the device such as the APD element 231. Generally the silicon device reduces the quantum efficiency in the ultraviolet region. In order to remedy the aforementioned problem, the silicon nitride based material or gallium nitride based material is used to produce the device. Alternatively, a wavelength conversion material (scintillator) 235 is disposed between the micro lens array 228 described in FIG. 11A the APD elements 231 manufactured through the silicon process so that the ultraviolet radiation is converted into the long wavelength light (visible light) to allow incidence of the long wavelength light onto the light receiving surface of the APD element 231 as shown in FIG. 11B. This makes it possible to substantially improve the conversion efficiency.

### Example 2

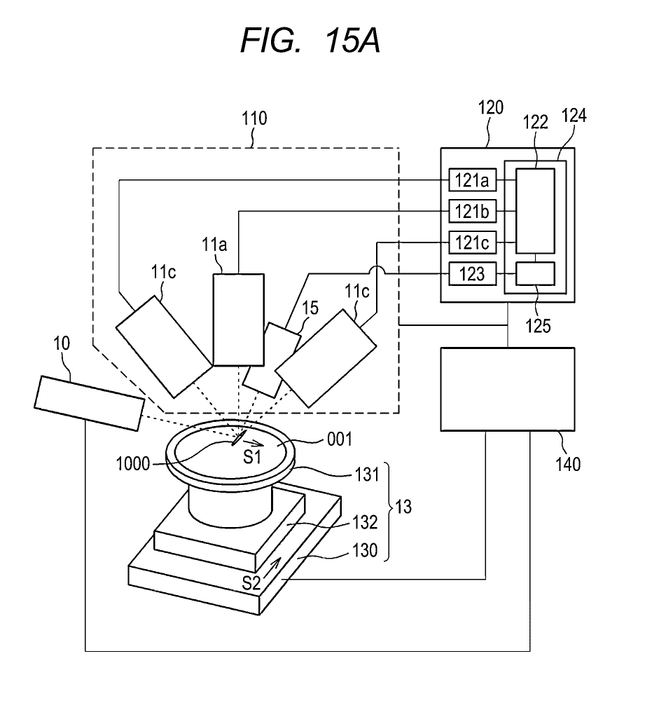

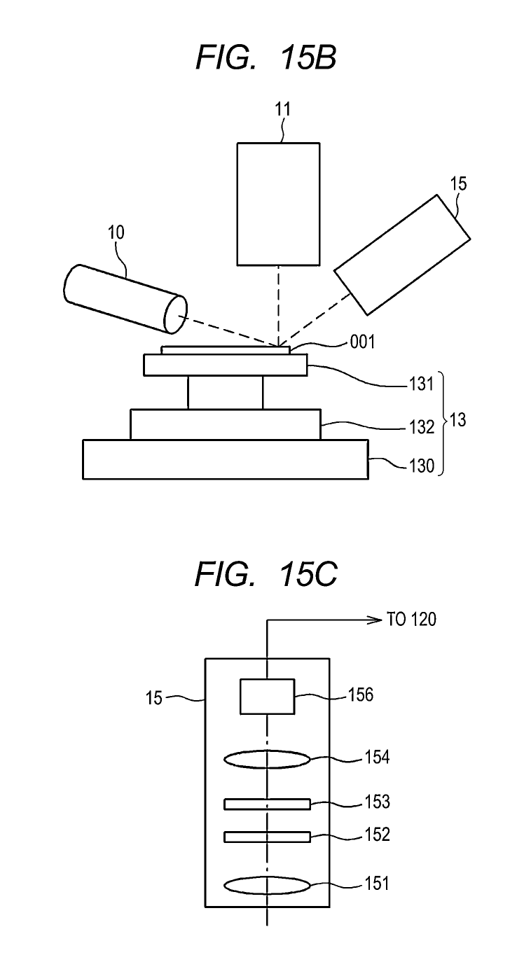

The structure formed by adding the optical system for detecting the backscattered light to the one described in Example 1 referring to FIG. 1 will be described. FIGS. 15A to 15C show the structure of the inspection device according to this embodiment. The same structures as those described in Example 1 referring to FIG. 1 are designated with the same codes.

The illumination optical system unit 110, and the first to the third detection units 11a, 11b, 11c of the detection optical system unit 110 shown in FIG. 15A are the same as those described in Example 1 referring to FIG. 1. The stage unit 13 also has the same structure as the one described in Example 1 referring to FIG. 1.

The backscattered light detection unit 15 of the detection optical system unit 110 is installed at a slant with respect to the wafer 001 as shown in FIG. 15B. The unit detects the backscattered light of the scattered light generated from the thin linear area 1000 on the wafer 001 irradiated with the illumination light emitted from the illumination optical unit 10.

The inspection device according to the embodiment is configured to allow the backscattered light detection unit 15 to detect relatively large quantity of the scattered light from the defect, which may cause the first to the third detection units 11a, 11b, 11c of the detection optical system unit 110 to be saturated. This allows expansion of the dynamic range for the defect detection.

FIG. 15C shows the structure of the backscattered light detection unit 15. The backscattered light detection unit 15 includes an objective lens 151, an aperture control filter 152, a polarizing filter 153, a condensing lens 154, and a detector 156. Functions of the aperture control filter 152 and the polarizing filter 153 are the same as those of the aperture control filters 112a to 112c, and the polarizing filters 113a to 113c as described in Example 1. The detector 151 is composed of the photomultiplier, and detects the light among those generated from the thin linear area 1000 on the wafer 001, which has been incident onto the objective lens 151, passed through the aperture control filter 152 and the polarizing filter 153, and condensed by the condensing lens 154.

Detection sensitivity of the detector 156 is lower than that of the parallel type photon count sensors 115a to 115c.

The backscattered light detection unit 15 is configured as the light condensing system rather than the image forming system. Therefore, it is unable to locate the area where the defect exists in the thin linear region 1000 on the wafer 001 even if the scattered light from the defect on the wafer 001 is detected. However, the first to the third detection units 11a, 11b, 11c can also detect the scattered light that can be detected by the backscattered light detection unit 15. The first to the third detection units 11a, 11b, 11c are configured as the image forming systems as described in Example 1. It is therefore possible to locate the position where the scattered light is generated in the thin linear area 1000 on the wafer 001.

The information on quantity of the scattered light detected by the backscattered light detection unit 15 is combined with the information on the position where the scattered light is generated, which is detected by the first to third detection units 11a, 11b, 11c to ensure acquisition of the information on position and size of the relatively large defect on the wafer 001.

The aforementioned process is executed by a signal processing section 125 of the signal processing unit 120. Specifically, the scattered light detection signal detected by the backscattered light detection unit 15 is input to the signal processing section 123 of the signal processing unit 120 where the noise eliminating process is executed. The signal is then input to the signal processing section 125. The signal detected by the detection units 11a, 11b, 11c are input to signal processing sections 121a, 121b, 121c where the filtering process is executed, and then further processed through the signal processing-control unit 122 so that the minute defect is detected. Meanwhile, in case the strong scattered light from the wafer 001 is received by the detection units 11a, 11b, 11c, the photon count sensors 115a, 115b, 115c are saturated. Then the signal saturated to the constant level is input to the signal processing-control unit 122. Upon reception of the saturated signal, the signal processing-control unit 122 sends the information on the position where the scattered light is generated on the wafer 001 that saturates the signal to the signal processing section 125. The signal processing section 125 determines the defect size from the level of the signal detected by the backscattered light detection unit 15. By integrating the determination result and the scattered light generation position information from the signal processing-control unit 122, it is possible to get information on the position and size of the defect on the wafer 001.

In this embodiment, the backscattered light detection unit 15 is disposed as the optical system for detecting the relatively strong scattered light. However, it is possible to add the optical system for detecting the forward scattered light, or the optical system for detecting the backscattered light or the forward scattered light at the different elevation angle.

According to the present embodiment, the first to the third detection units 11a, 11b, 11c are allowed to detect the minute defect which cannot be detected by the detector 151 configured as the photomultiplier. This makes it possible to expand the dynamic range for the defect detection.

### REFERENCE SIGNS LIST

001 . . . wafer
01 . . . control unit
10 . . . illumination optical system unit
101 . . . light source
102 . . . polarization state control unit
103 . . . beam forming unit
104 . . . thin linear condensing optical system
1000 . . . thin linear illumination area
11 . . . detection optical system
11a, 11b, 11c . . . detection optical system unit
111a, 111b, 111c . . . objective lens
112a, 112b, 112c . . . aperture control filter
113a, 113b, 113c . . . polarizing filter
114a, 114b, 114c . . . image forming lens
115a, 115b, 115c . . . parallel type photon count sensor
12, 120 . . . signal processing unit
121a, 121b, 121c . . . signal processing section
13 . . . stage unit
14, 140 . . . control unit
15 . . . backscattered light detection unit

1. A defect inspection method comprising the steps of:
irradiating a linear area of a surface of a specimen placed on a table movable in a plane with an illumination light from a direction inclined with respect to a normal direction of the specimen surface;
condensing a scattered light generated from the specimen irradiated with the illumination light through a plurality of detection optical systems including objective lenses disposed in a plane including the normal direction of the specimen surface substantially orthogonal to a longitudinal direction of the linear area of the specimen surface irradiated with the illumination light;
detecting the condensed scattered light by a plurality of detectors respectively corresponding to the plurality of detection optical systems; and
detecting a defect on the specimen surface by processing a scattered light detection signal derived from detection by the plurality of detectors,
wherein, the step of condensing a scattered light includes;
condensing the scattered light generated from the specimen irradiated with the illumination light through the plurality of optical systems including the objective lens having an aperture angle with respect to the longitudinal direction of the linear area of the specimen surface irradiated with the illumination light, and an aperture angle with respect to a direction substantially orthogonal to the longitudinal direction, both of which being different from each other; and
wherein, the step of detecting the condensed scattered light includes;
detecting images with a magnification in the longitudinal direction of the linear area, and a magnification in the direction substantially orthogonal to the longitudinal direction of the linear area, both of which are different from each other with the plurality of detectors with the scattered light condensed by the respective objective lenses of the plurality of optical systems.

2. The defect inspection method according to claim 1, wherein a part of the scattered light generated from the specimen irradiated with the illumination light, which scatters in a direction different from that of the plurality of detection optical systems is condensed and detected, and a signal derived from condensing and detecting the part of the scattered light, and a signal derived from detection by the plurality of detection optical systems are used to detect the defect that generates the scattered light to be saturated by the detectors of the plurality of detection optical systems.

3. A defect inspection method comprising the steps of:
irradiating a linear area of a surface of a specimen placed on a table movable in a plane with an illumination light from a direction inclined with respect to a normal direction of the specimen surface;
condensing a scattered light generated from the specimen irradiated with the illumination light through a plurality of detection optical systems including objective lenses disposed in a plane including a normal direction of the specimen surface substantially orthogonal to a longitudinal direction of the linear area of the specimen surface irradiated with the illumination light for detection by a plurality of two-dimensional detectors respectively corresponding to the plurality of detection optical systems;
condensing a part of the scattered light generated from the specimen irradiated with the illumination light, which scatters in a direction different from that of the plurality of detection optical systems for detection by a detector with lower sensitivity than that of the two-dimensional detector; and
detecting a minute defect on the specimen by processing a signal derived from detection by the plurality of two-dimensional detectors, and a relatively large defect that generates the scattered light to be saturated by the plurality of two-dimensional detectors using a signal derived from detection by the detector with lower sensitivity than that of the two-dimensional detector, and a signal derived from detection by the plurality of two-dimensional detectors.

4. The defect inspection method according to claim 3, wherein the scattered light generated from the specimen is condensed by the objective lens with an aperture angle with respect to a longitudinal direction of the linear area, which is larger than an aperture angle with respect to a direction substantially orthogonal to the longitudinal direction.

5. The defect inspection method according to claim 3, wherein the plurality of detection optical systems form images of the linear area with the scattered light having a larger magnification in a direction substantially orthogonal to a longitudinal direction of the linear area than a magnification in the longitudinal direction of the linear area on the respective detectors of the plurality of detection optical systems.

6. A defect inspection device comprising:
a table movable in a plane having a specimen placed thereon;
an illumination light irradiating section for irradiating a linear area of a surface of the specimen placed on the table with an illumination light from a direction inclined to a normal direction of the specimen surface;
a detection optical system section which includes a plurality of detection optical systems disposed in a plane including a normal line of the specimen surface in a direction substantially orthogonal to a longitudinal direction of the linear area of the specimen surface irradiated with the illumination light, each of which has an objective lens for condensing a scattered light generated from the linear area of the specimen surface irradiated with the illumination light from the illumination light irradiating section, and a two-dimensional detector for detecting the scattered light condensed by the objective lens; and
a signal processing section which processes a signal derived from detection by the respective two-dimensional detectors of the plurality of detection optical systems of the detection optical system section to detect the defect on the specimen,
wherein the objective lens of the detection optical system has an aperture angle in a direction along the longitudinal direction of the linear area of the specimen surface irradiated with the illumination light, and an aperture angle in a direction substantially orthogonal to the longitudinal direction, both of which are different from each other; and
wherein the detection optical system forms an image on the two-dimensional detector with the scattered light condensed by the objective lens, having a magnification in the longitudinal direction of the linear area different from a magnification in a direction substantially orthogonal to the longitudinal direction of the linear area.

7. The defect inspection device according to claim 6, further comprising an inclined detection optical system which condenses a part of the scattered light generated from the specimen irradiated with the illumination light, which scatters in a direction different from that of the plurality of detection optical systems for detection, wherein the signal processing section uses a signal derived from condensing and detecting the part of the scattered light by the inclined detection optical system and a signal derived from detection by the plurality of detection optical systems to detect the defect that generates the scattered light to be saturated by the two-dimensional detectors of the plurality of detection optical systems.

8. A defect inspection device comprising:
a table movable in a plane having a specimen placed thereon;
an illumination light irradiating section that irradiates a linear area of a surface of the specimen placed on the table with a illumination light from a direction inclined with respect to a normal direction of the specimen surface;
a detection optical system section which includes a plurality of detection optical systems disposed in a plane including a normal line of the specimen surface in a direction substantially orthogonal to a longitudinal direction of a linear area of the specimen surface irradiated with the illumination light, each of which has an objective lens for condensing a scattered light generated from the linear area of the specimen surface irradiated with the illumination light from the illumination light irradiating section, and a two-dimensional detector for detecting the scattered light condensed by the objective lens, and a detector with sensitivity lower than that of the two-dimensional detector for condensing and detecting a part of the scattered light generated from the specimen irradiated with the illumination light, which scatters in a direction different from those of the plurality of detection optical systems; and
a signal processing section which detects a minute defect on the specimen by processing a signal derived from detection by the plurality of two-dimensional detectors, and detects a relatively large defect that generates the scattered light to be saturated by the plurality of two-dimension detectors, using a signal derived from detection by the detector with sensitivity lower than that of the two-dimensional detector and a signal derived from detection by the plurality of two-dimensional detectors.

9. The defect inspection device according to claim 8, wherein the objective lens of the detection optical system has an aperture angle in a direction along the longitudinal direction of the linear area of the specimen surface irradiated with the illumination light, which is larger than an aperture angle in a direction substantially orthogonal to the longitudinal direction.

10. The defect inspection device according to claim 8, wherein the detection optical system includes a cylindrical lens for enlarging an image with the scattered light in a direction substantially orthogonal to the longitudinal direction of the linear area condensed by the objective lens so that the enlarged image is formed on the two-dimensional detector.

11. The defect inspection device according to claim 8, wherein the two-dimensional detector counts photons of light condensed by the objective lens from those generated from the linear area of the specimen surface irradiated with the illumination light from the illumination light irradiating section.

12. The defect inspection device according to claim 11, wherein the two-dimensional detector is a detector configured by two dimensionally array of avalanche photodiode elements which are operated in Geiger mode.

13. The defect inspection method according to claim 1, wherein the scattered light generated from the specimen is condensed by the objective lens with an aperture angle with respect to a longitudinal direction of the linear area, which is larger than an aperture angle with respect to a direction substantially orthogonal to the longitudinal direction.

14. The defect inspection method according to claim 1, wherein the plurality of detection optical systems form images of the linear area with the scattered light having a larger magnification in a direction substantially orthogonal to a longitudinal direction of the linear area than a magnification in the longitudinal direction of the linear area on the respective detectors of the plurality of detection optical systems.

15. The defect inspection device according to claim 6, wherein the objective lens of the detection optical system has an aperture angle in a direction along the longitudinal direction of the linear area of the specimen surface irradiated with the illumination light, which is larger than an aperture angle in a direction substantially orthogonal to the longitudinal direction.

16. The defect inspection device according to claim 6, wherein the detection optical system includes a cylindrical lens for enlarging an image with the scattered light in a direction substantially orthogonal to the longitudinal direction of the linear area condensed by the objective lens so that the enlarged image is formed on the two-dimensional detector.

17. The defect inspection device according to claim 6, wherein the two-dimensional detector counts photons of light condensed by the objective lens from those generated from the linear area of the specimen surface irradiated with the illumination light from the illumination light irradiating section.

18. The defect inspection device according to claim 17, wherein the two-dimensional detector is a detector configured by two dimensionally array of avalanche photodiode elements which are operated in Geiger mode.
